(19) United States
(12) Patent Application Publication
(10) Pub. No.: US 2015/0165814 A1
(43) Pub. Date: Jun. 18, 2015

(54) Multi-Purpose Writing Instrument

(71) Applicant: Sidney Ru, Duarte, CA (US)

(72) Inventor: Sidney Ru, Duarte, CA (US)

(21) Appl. No.: 14/529,514

(22) Filed: Oct. 31, 2014

Related U.S. Application Data
(60) Provisional application No. 61/909,756, filed on Nov. 27, 2013.

(51) Int. Cl. B43K 29/00; B43K 7/12

(52) U.S. Cl. CPC B43K 29/004; B43K 7/12

(57) ABSTRACT

The present invention is a multi-function apparatus that can include a writing instrument, stylus, and integral microfiber retractable cloth.

### PRIORITY CLAIM

This non-provisional patent application claims priority to Provisional Patent Application, Ser. No. 61/909,756 filed on Nov. 27, 2013.

The claimed invention is multi-function apparatus that can include, among other things, a click-action ballpoint pen, an integral touch screen stylus and an internally housed, and an integral retractable microfiber cloth.

This apparatus is a compatible accessory for numerous types of devices including, but not limited to, any touch screen tablet or phone. By way of example, the integral stylus (which can have a conductive and/or capacitance tip which can be any color or no color at all) can be used to select applications, compose messages and perform other functions of the touch screen device. The integral microfiber cloth, which can be retractable, provides a mechanism to clean the touch screen device, or any other product or device. Finally, the click-action pen (which can be any color or shape) can be used for writing.

### DESCRIPTION OF FIGURES

FIG. 1 shows one embodiment of the apparatus with a microfiber cloth in the retracted position, the tip of the pen in the retracted position, and the black stylus tip on the top (i.e., plunger) portion of the pen (but it can also be located elsewhere in other embodiments if desired).

FIG. 2 shows one embodiment of the apparatus with a microfiber cloth extended (containing an image if desired, such as this one showing a flag), the pen in writing mode with the tip extended, and the black stylus tip at the end of the plunger. The apparatus is configured to allow the user to click the plunger to keep the microfiber extended and then to click it again to retract the microfiber cloth.

FIG. 3 shows a close up of the stylus (which again can be any color, or even clear if desired) that is located on the plunger of the click-action pen.

FIG. 4 shows another embodiment of apparatus where the stylus is located at the writing end of the pen such that the writing portion of the pen (i.e., the tip) extends through it.

FIG. 5 shows the writing end of the pen portion an embodiment where the stylus is located in a position other than at the writing end.

FIG. 6 illustrates the internal workings of the apparatus (again, which can be in any color or even no color):

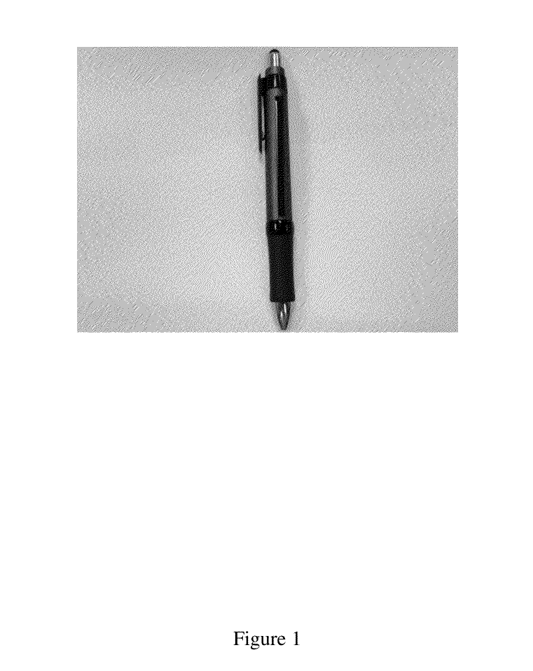

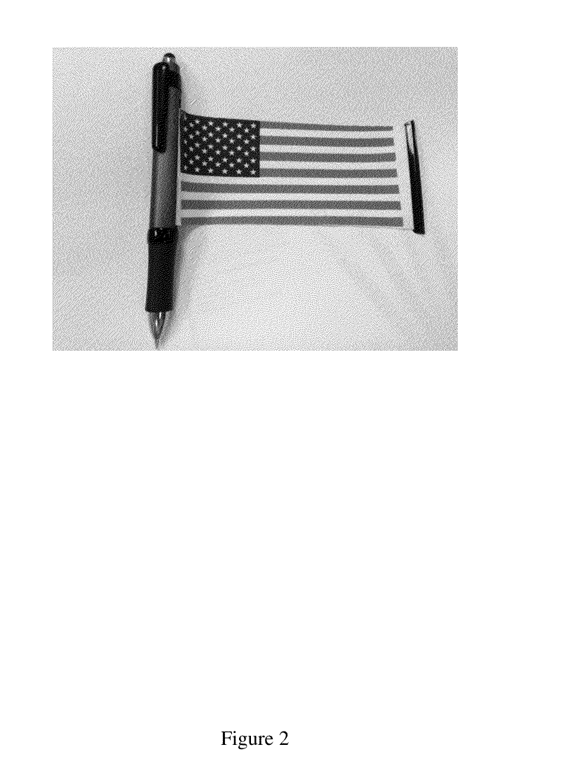

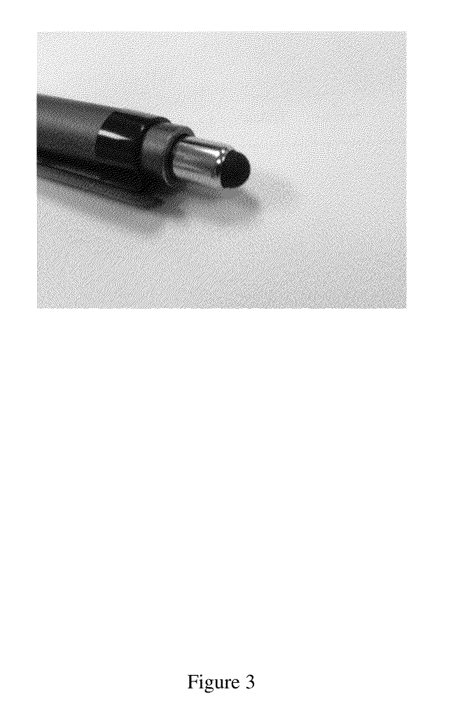

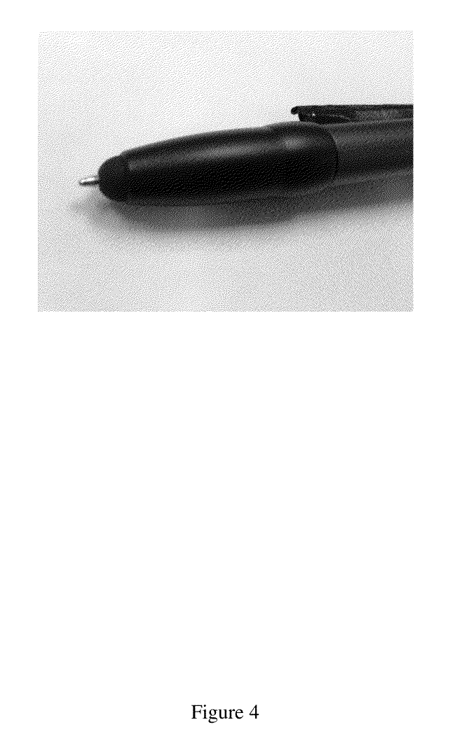

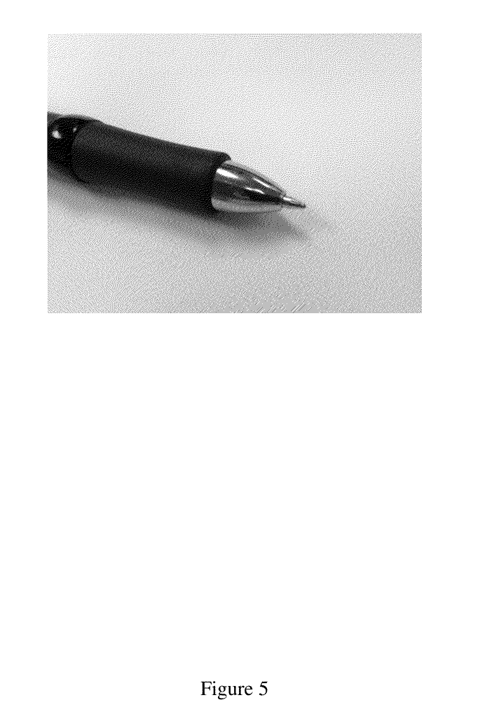

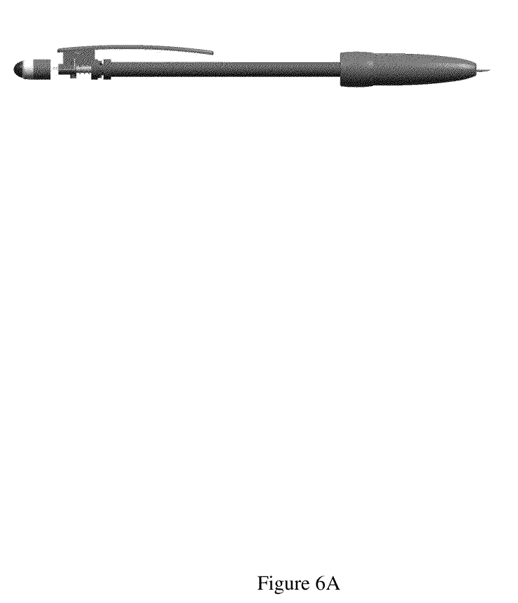

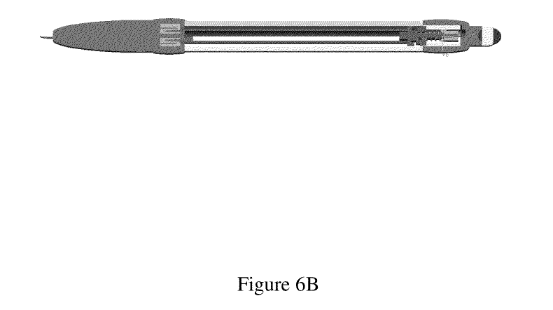

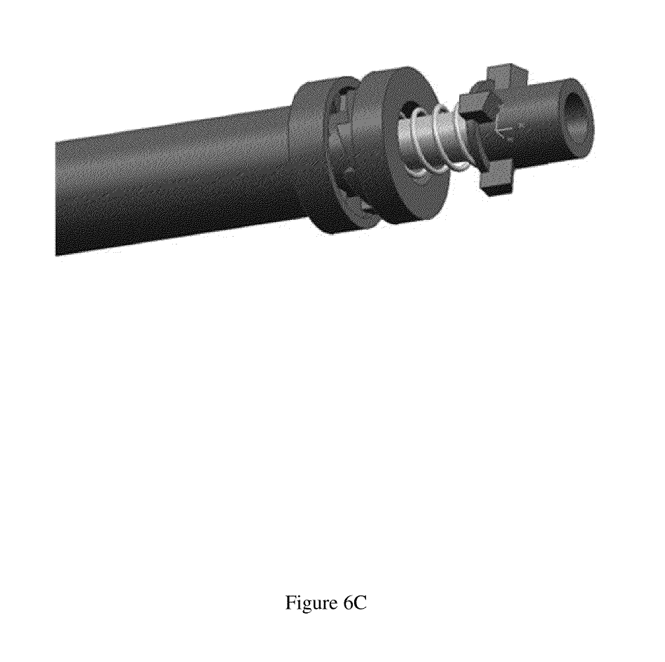

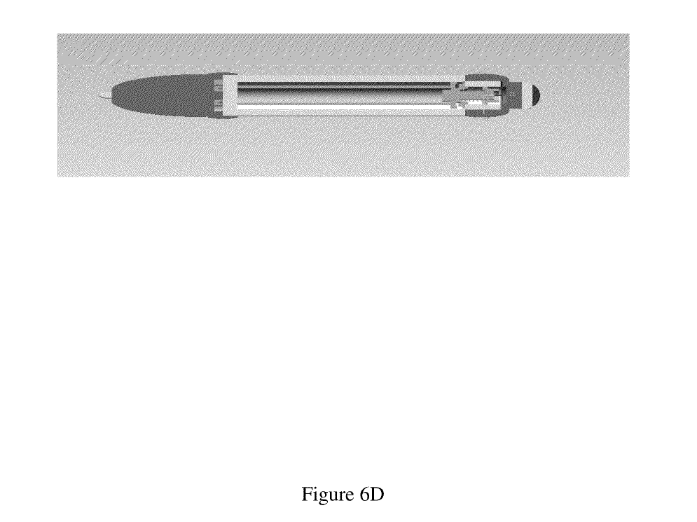

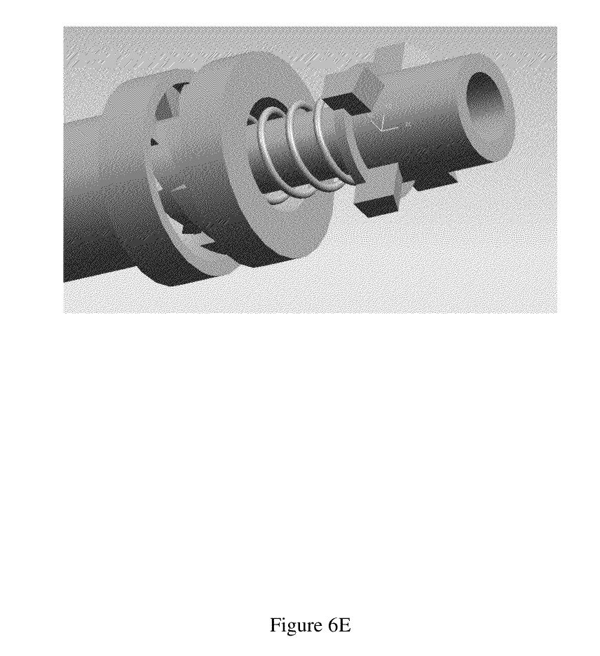

What is claimed:

1. An apparatus comprising:
A writing instrument; and
An integral, retractable microfiber cloth.
